(19) United States
(12) Patent Application Publication
(10) Pub. No.: US 2018/0334013 A1
(43) Pub. Date: Nov. 22, 2018

(54) VEHICLE HVAC SYSTEM WITH ODOR CONTROL

(71) Applicant: MAGNA ELECTRONICS INC., Auburn Hills, MI (US)

(72) Inventor: Krishna Koravadi, Rochester Hills, MI (US)

(21) Appl. No.: 15/985,753

(22) Filed: May 22, 2018

Related U.S. Application Data
(60) Provisional application No. 62/509,209, filed on May 22, 2017.

(51) Int. Cl. B60H 1/00; B60H 3/00

(52) U.S. Cl. CPC B60H 1/00771; B60H 3/0092; B60H 1/008

(57) ABSTRACT

A control system for a vehicle includes an odor sensor disposed at a vehicle and operable to sense odors exterior of the vehicle. A controller is operable to control an external air intake actuator of the vehicle. The controller receives an input from the odor sensor and, responsive to the controller determining that a sensed odor is above a threshold odor level, the controller actuates the external air intake actuator to close the external air intake. The controller, responsive to actuation of a user input and a global positioning system of the vehicle, may save a geographical location as a bad odor zone and may actuate the external air intake actuator as the vehicle approaches the bad odor zone during subsequent drives of the vehicle along that road.

### CROSS REFERENCE TO RELATED APPLICATION

The present application claims the filing benefits of U.S. provisional application Ser. No. 62/509,209, filed May 22, 2017, which is hereby incorporated herein by reference in its entirety.

### FIELD OF THE INVENTION

The present invention relates generally to air circulation systems for a vehicle.

### BACKGROUND OF THE INVENTION

At present when the HVAC (heating, ventilation and air conditioning) system of a vehicle is operating in the external air circulation mode and while the vehicle is driven along a road, the vehicle may pass through a stretch of the route where there will be bad external smell/odor that enters inside the cabin via the air circulation system. Once it enters it takes time to get cleared and it may not be comfortable for the passengers. If the vehicle is regularly driven through the stretch of the route with bad external odor, the driver needs to keep track of the location where the bad odor is present in the route and switch to internal air circulation mode manually.

### SUMMARY OF THE INVENTION

The present invention provides an in-cabin odor prevention system for a vehicle that includes an odor sensor disposed at a vehicle and operable to sense odors exterior of the vehicle, and a controller (such as the HVAC controller of the vehicle) operable to control an external air intake actuator of the vehicle. The controller receives an input from the odor sensor and processes that input and, responsive to the controller determining that a sensed odor is above a threshold odor level, the controller actuates the external air intake actuator to close the external air intake.

Optionally, the controller receives an input from a global positioning system of the vehicle and learns areas associated with bad odors when the vehicle is repetitively driven past such areas. After learning at least one bad odor area, the controller actuates the external air intake actuator to close the external air intake as the vehicle approaches the learned at least one bad odor area.

Optionally, and desirably, after the controller determines that the sensed odor is above the threshold odor level and actuates the external air intake actuator to close the external air intake, the controller and the odor sensor continue to sense and process and monitor odors exterior of the vehicle. The controller, responsive to determining that the sensed odor is no longer above the threshold odor level, may return the HVAC system to the settings it was at before the bad odor was determined, such as by actuating the external air intake actuator to open the external air intake.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with an in-cabin odor prevention system in accordance with the present invention; and

FIG. 2 is block diagram of the in-cabin odor prevention system of the present invention.

### DESCRIPTION OF THE PREFERRED EMBODIMENTS

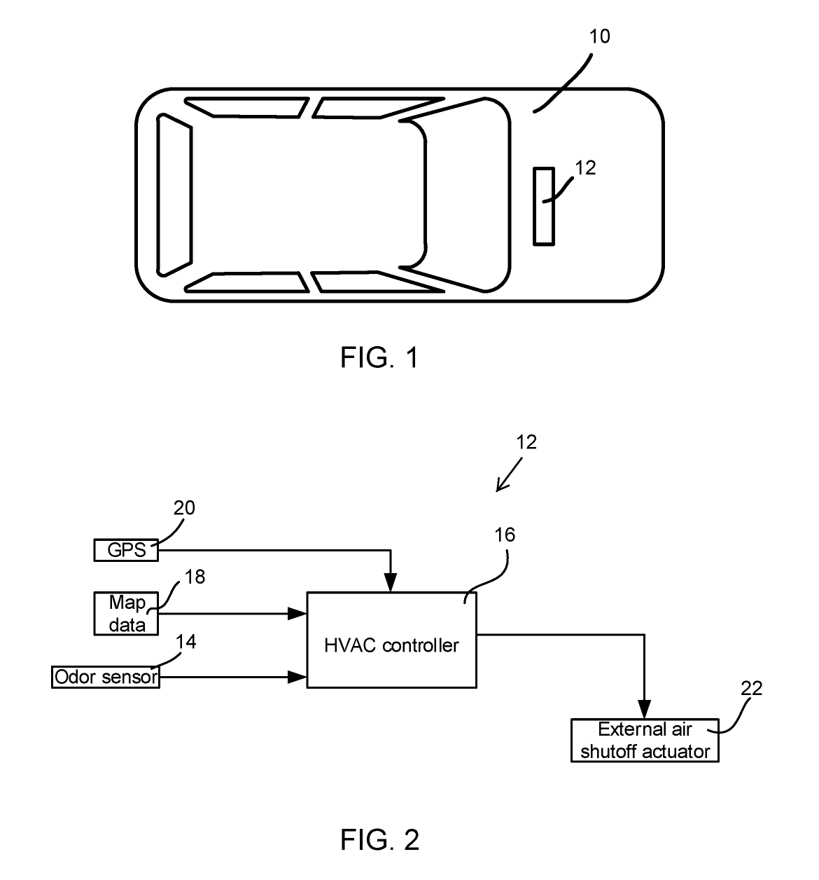

Referring now to the drawings and the illustrative embodiments depicted therein, a vehicle 10 is equipped with an in-cabin odor prevention system 12 (FIG. 1). The in-cabin odor prevention system 12 includes an odor sensor 14 that can sense odors and communicate sensing of odors to a controller 16 of the HVAC system of the vehicle (FIG. 2). The HVAC controller 16 includes an input or data indicative of map data 18 and an input from a GPS system 20. The HVAC controller 16 processes the inputs, and responsive to the processing of the inputs received at the HVAC controller 16 determining that the vehicle may be approaching an area having a foul or bad odor, the HVAC controller 16 may automatically control an external air shutoff actuator 22 to shut off or close the air intake for the external air circulation or ventilation function of the HVAC system, as discussed below.

The system of the present invention comprises a method and apparatus to limit or substantially preclude or prevent the bad smell/odor from entering inside the vehicle cabin. A smell/odor detection sensor is added to the existing HVAC controller. If the HVAC controller is operating in its external air circulation mode and the odor sensor senses a bad odor from the environment (as determined via processing of an output of the odor sensor and determining that the output is indicative of an odor above a threshold level), the HVAC controller can immediately switch to the internal air recirculation mode so that it prevents the odor to enter in to the cabin.

If the vehicle travels the same route multiple times and if one or more particular patches or segments of the route are known or learned to have bad odors associated with them, the system can learn the location and automatically close or shut off the external air circulation function before the vehicle arrives at the patch or segment. For example, if the vehicle is equipped with GPS and map data, an algorithm in the HVAC controller learns the location information during one or more passes of the bad odor areas, and can then automatically switch to internal air circulation mode prior to reaching the location with odor after that location is learned and saved in the system. After passing the patch or route segment associated with a bad odor the HVAC controller can automatically revert back to the original user setting.

Optionally, the system may learn the areas where a bad odor is present responsive to actuation of a user input. For example, when the vehicle is driven into an area associated with a bad or unpleasant odor, an occupant of the vehicle may actuate a user input and the system may learn that the geographical vehicle location at which the input was actuated is a bad odor area. Thus, in future drives, when the vehicle is approaching that location, the system knows to shut off the external air intake. The system may shut off the external air intake a predetermined distance before the location at which the input was actuated, such as one mile before or half a mile before the vehicle arrives at that location, so that the external air intake is closed before the bad odors can enter the vehicle. Optionally, the system may learn an exit area where an occupant of the vehicle may actuate a second user input (such as actuating a different input or button or actuating the same input a second time), whereby the system learns a location at which it is safe to re-open the external air intake.

Thus, the controller may be responsive to a user actuatable input and, responsive to actuation of the user actuatable input as the vehicle is traveling along a particular road, the controller saves the then current geographical location as a beginning point or area of a bad odor zone or region. Responsive to a second actuation of the user actuatable input (such as actuation of the same user actuatable input a second time or actuation of a second user actuatable input) as the vehicle continues traveling along the road, the controller saves the then current geographical location as an end point or area of the bad odor zone. Then, during subsequent traveling of the vehicle along that road, the controller, responsive to the global positioning system of the vehicle, automatically actuates the external air intake actuator to close the external air intake as the vehicle approaches the geographical location that was previously (during a previous driving pass of the vehicle along that road) saved as the beginning of the bad odor zone, and the controller automatically actuates the external air intake actuator to open the external air intake after the vehicle passes the geographical location that was previously saved as the end of the bad odor zone.

FIG. 2 shows a block diagram of the odor prevention system 12, which includes an odor sensor 14 installed at the in-cabin air intake of the HVAC system of the subject vehicle 10. The odor sensor 14 measures the odor in the air intake port and communicates to the HVAC controller 16. In a vehicle with no GPS or map data, the algorithm executed in the HVAC controller 16 will switch to its internal cabin air circulation mode when an odor is detected that is above a threshold level and will remain in that mode until the external odor is below the pre-calibrated value or threshold level. When the system determines that the external odor is less than the pre-calibrated value, the algorithm will switch back to the user preselected mode.

If the vehicle 10 is equipped with a GPS system 20 and map data 18, the algorithm executed on the HVAC controller 16 monitors the external odor and if the external odor is greater than a certain pre-calibrated or threshold value, then, along with the switch to the internal air circulation mode, the system also keeps track of the location in the route so that if the vehicle travels multiple times in the same route and the odor occurs consistently, then it learns this and, once learned, the system can switch to the internal cabin air recirculation mode before the vehicle 10 reaches the learned location.

Thus, the presently claimed invention provides an in-cabin odor prevention system that senses odor at the vehicle and shuts off the external air intake when the system determines that the odor is greater than a threshold level (which may be set or customized by the vehicle driver or owner or occupant or passenger of the vehicle, so that the system may be set to be more or less sensitive to odors). The system may also operate in conjunction with a GPS system or navigation system of the vehicle, and may learn areas that the vehicle typically passes that have bad odors associated with them. After such learning, the system stores those locations in memory and when the vehicle again approaches those locations, the system automatically shuts down the external air intake, preferably before the vehicle arrives at the locations, such that the system automatically precludes bad odor intake into the vehicle, without any intervention from a driver or occupant of the vehicle.

The system may have an odor classifier that detects/senses and analyzes odors, and then classifies the detected odor or odors and controls the HVAC system responsive to the odor classification. If a detected odor is classified as an undesirable odor, the system closes the external air intake to mitigate odor entry into the vehicle. If a detected odor is not classified as an undesirable odor, the system allows the external air intake to remain open as the vehicle travels along the road. A user may override the system and manually shut the external air intake at any time, and the user may adjust or control the system to learn or re-classify an odor as a bad odor (for situations where the system does not classify a detected odor as a bad odor, but the driver or occupant of the vehicle wants that odor classified as a bad odor for future situations where an odor like that is detected.

The present invention thus adds intelligence to the HVAC system so that it will know at which location there is a bad smell or odor in the environment so that the control can shut off the external air suction or intake and use the internal air circulation only. If the user detects the smell and reacts to the smell in the cabin of the vehicle, it will be too late as the bad smell will enter the cabin and it will take lot of time to flush out. Thus, the system may learn a geographical location of a smell or may detect a smell or odor before it enters the vehicle through the air intake, so that the HVAC external air intakes may be shut down before the vehicle or at least before the air intakes actually encounter the bad odor.

Optionally, the system, even after learning bad odor locations, may continue to monitor odor levels at those locations when the vehicle drives past or through those locations, and may “unlearn” or remove those locations from being trigger points if the system later determines that those locations are no longer associated with bad odors. For example, if an asphalt road construction takes several days/weeks to complete, the system may, as the vehicle is driven past or along the construction zone, learn and store that area as a bad odor area, such that the air intake is closed each time the vehicle approaches and passes through that area. However, when the construction is completed, the system can later determine that the odor is no longer associated with that area and can remove that area from its memory as a bad odor zone or region (optionally, the system may unlearn bad odor regions via actuation of a user input by an occupant of the vehicle). The second threshold level at which the system re-opens the vent after closing due to detection of a bad odor at a first threshold level may be the same as the first threshold level or may be lower than the first threshold level (to make sure that the vehicle is past the odor zone or region before the vent is re-opened).

Optionally, the controller and odor sensor only monitor the external odors when the vehicle HVAC system is operating to draw in external air (such as in an external air circulation mode). Optionally, the controller and odor sensor may also or otherwise monitor the external odors when the vehicle is being driven with one or more windows opened. Responsive to determination that the vehicle is approaching or at an area with a bad odor, the system may automatically close the windows (and close the external air intake) or may generate an alert to the occupant(s) of the vehicle that the vehicle is approaching or at a bad odor zone.

Optionally, the system may also communicate with other systems of other vehicles or infrastructure, and may control the external air intake responsive to odors detected by other vehicles or infrastructure ahead of the equipped or subject vehicle. For example, the system may communication with other systems or sensors via a vehicle-to-vehicle communication system or a vehicle-to-infrastructure communication system or the like. Such car2car or vehicle to vehicle (V2V) and vehicle-to-infrastructure (car2X or V2X or V2I or 4G or 5G) technology provides for communication between vehicles and/or infrastructure based on information provided by one or more vehicles and/or information provided by a remote server or the like. Such vehicle communication systems may utilize aspects of the systems described in U.S. Pat. Nos. 6,690,268; 6,693,517 and/or 7,580,795, and/or U.S. Publication Nos. US-2014-0375476; US-2014-0218529; US-2013-0222592; US-2012-0218412; US-2012-0062743; US-2015-0251599; US-2015-0158499; US-2015-0124096; US-2015-0352953; US-2016-0036917 and/or US-2016-0210853, which are hereby incorporated herein by reference in their entireties.

The control system of the present invention may be suitable for manually driven vehicles or autonomous vehicles (where the occupant may be a driver or passenger). For autonomous vehicles suitable for deployment with the system of the present invention, an occupant of the vehicle may, under particular circumstances, be desired or required to take over operation/control of the vehicle and drive the vehicle so as to avoid potential hazard for as long as the autonomous system relinquishes such control or driving. Such occupant of the vehicle thus becomes the driver of the autonomous vehicle. As used herein, the term “driver” refers to such an occupant, even when that occupant is not actually driving the vehicle, but is situated in the vehicle so as to be able to take over control and function as the driver of the vehicle when the vehicle control system hands over control to the occupant or driver or when the vehicle control system is not operating in an autonomous or semi-autonomous mode.

Typically an autonomous vehicle would be equipped with a suite of sensors, including multiple machine vision cameras deployed at the front, sides and rear of the vehicle, multiple radar sensors deployed at the front, sides and rear of the vehicle, and/or multiple lidar sensors deployed at the front, sides and rear of the vehicle. Typically, such an autonomous vehicle will also have wireless two way communication with other vehicles or infrastructure, such as via a car2car (V2V) or car2x communication system.

Changes and modifications in the specifically described embodiments can be carried out without departing from the principles of the invention, which is intended to be limited only by the scope of the appended claims, as interpreted according to the principles of patent law including the doctrine of equivalents.

1. A control system for a vehicle, said control system comprising:
an odor sensor disposed at a vehicle and operable to sense odors exterior of the vehicle;
a controller operable to control an external air intake actuator of the vehicle; and
wherein said controller receives an input from said odor sensor and, responsive to said controller determining that a sensed odor is above a threshold odor level, said controller actuates the external air intake actuator to close the external air intake.

2. The control system of claim 1, wherein said odor sensor senses odors exterior of the vehicle as the vehicle is driven along a road.

3. The control system of claim 1, wherein said controller receives an input from a global positioning system of the vehicle and, as the vehicle is driven, learns regions associated with odors above the threshold level.

4. The control system of claim 3, wherein, after learning at least one odor region where odors are above the threshold level, said controller actuates the external air intake actuator to close the external air intake as the vehicle approaches the learned at least one odor region.

5. The control system of claim 1, wherein said controller comprises an HVAC controller of the vehicle.

6. The control system of claim 1, wherein, after said controller determines that the sensed odor is above the threshold odor level and actuates the external air intake actuator to close the external air intake, said controller and said odor sensor continue to sense and process odors exterior of the vehicle, and wherein said controller, responsive to determining that the sensed odor is below a second threshold odor level, actuates the external air intake actuator to open the external air intake.

7. The control system of claim 6, wherein the second threshold odor level is below the threshold odor level at which the external air intake actuator closes the external air intake.

8. The control system of claim 6, wherein the second threshold odor level is the same as the threshold odor level at which the external air intake actuator closes the external air intake.

9. The control system of claim 1, wherein said controller is responsive to a user actuatable input and, responsive to actuation of the user actuatable input as the vehicle is traveling along a road, said controller saves the then current geographical location as a beginning of a bad odor zone.

10. The control system of claim 9, wherein, responsive to a second actuation of the user actuatable input as the vehicle continues traveling along the road, said controller saves the then current geographical location as an end of the bad odor zone.

11. The control system of claim 10, wherein, during subsequent traveling of the vehicle along the road, said controller automatically actuates the external air intake actuator to close the external air intake as the vehicle approaches the saved beginning of the bad odor zone, and wherein said controller automatically actuates the external air intake actuator to open the external air intake after the vehicle passes the saved end of the bad odor zone.

12. A control system for a vehicle, said control system comprising:
an odor sensor disposed at a vehicle and operable to sense odors exterior of the vehicle;
a controller operable to control an external air intake actuator of the vehicle; and
wherein said controller receives a GPS input from a global positioning system of the vehicle;
wherein said controller receives an input from said odor sensor and, responsive to said controller determining that a sensed odor is above a threshold odor level as the vehicle is driven, said controller actuates the external air intake actuator to close the external air intake, and responsive to the GPS input, said controller saves the geographical location associated with the sensed odor that is above the threshold level; and
wherein, during subsequent vehicle drives, and as the vehicle approaches the geographical location associated with the sensed odor that is above the threshold level, said controller automatically actuates the external air intake actuator to close the external air intake.

13. The control system of claim 12, wherein, after said controller determines that the sensed odor is above the threshold odor level and actuates the external air intake actuator to close the external air intake, said controller and said odor sensor continue to sense and process odors exterior of the vehicle, and wherein said controller, responsive to determining that the sensed odor is below a second threshold odor level, actuates the external air intake actuator to open the external air intake.

14. The control system of claim 13, wherein the second threshold odor level is below the threshold odor level at which the external air intake actuator closes the external air intake.

15. The control system of claim 13, wherein the second threshold odor level is the same as the threshold odor level at which the external air intake actuator closes the external air intake.

16. A control system for a vehicle, said control system comprising:
a controller operable to control an external air intake actuator of the vehicle; and
wherein said controller receives a GPS input from a global positioning system of the vehicle;
wherein said controller is responsive to a user actuatable input and, responsive to actuation of the user actuatable input as the vehicle is traveling along a road during a drive, said controller saves the then current geographical location as a beginning of a bad odor zone; and
wherein, during a subsequent drive of the vehicle along the road, and as the vehicle approaches the geographical location associated with the sensed odor that is above the threshold level, said controller automatically actuates the external air intake actuator to close the external air intake.

17. The control system of claim 16, wherein, responsive to a second actuation of the user actuatable input as the vehicle continues traveling along the road, said controller saves the then current geographical location as an end of the bad odor zone.

18. The control system of claim 17, wherein, during subsequent drives of the vehicle along the road, said controller automatically actuates the external air intake actuator to open the external air intake after the vehicle passes the saved end of the bad odor zone.

19. The control system of claim 16, comprising an odor sensor disposed at a vehicle and operable to sense odors exterior of the vehicle, wherein said controller receives an input from said odor sensor and, responsive to said controller determining that a sensed odor is above a threshold odor level, said controller actuates the external air intake actuator to close the external air intake.

20. The control system of claim 19, wherein, after said controller determines that the sensed odor is above the threshold odor level and actuates the external air intake actuator to close the external air intake, said controller and said odor sensor continue to sense and process odors exterior of the vehicle, and wherein said controller, responsive to determining that the sensed odor is below a second threshold odor level, actuates the external air intake actuator to open the external air intake.
